(19) United States
(12) Patent Application Publication
(10) Pub. No.: US 2018/0026938 A1
(43) Pub. Date: Jan. 25, 2018

(54) DETECTION AND SCHEDULING METHOD, DEVICE, AND NODE OF CONTENT DELIVERY NETWORK

(71) Applicant: ALIBABA GROUP HOLDING LIMITED, Grand Cayman (KY)

(72) Inventors: XIXI XIANG, CHENGDU (CN); JUNBAO KAN, BEIJING (CN); ZHAOYANG SONG, HANGZHOU (CN)

(21) Appl. No.: 15/656,475

(22) Filed: Jul. 21, 2017

(30) Foreign Application Priority Data
Jul. 21, 2016 (CN) 201610581465.X

(51) Int. Cl. H04L 29/12; H04L 29/08

(52) U.S. Cl. CPC H04L 61/2007; H04L 61/609; H04L 61/3055; H04L 67/10; H04L 61/1511

(57) ABSTRACT

Content Delivery Network (CDN) detection processing and scheduling methods, corresponding devices and nodes thereof are disclosed. The detection processing device issues one or more IP addresses in a first IP segment to a plurality of CDN nodes, receives link detection results reported by the plurality of CDN nodes, the link detection results comprising the information of time delay for accessing the IP addresses by the CDN nodes, and selects, from the plurality of CDN nodes, a priority scheduling node of the first IP segment according to the time delay information. The scheduling node searches for the priority scheduling node of the first IP segment according to the information of the first IP segment, and provides the information of the identified priority scheduling node to the user terminal.

### CROSS-REFERENCE TO RELATED APPLICATION

The present application is based on and claims priority to Chinese Patent Application No. 201610581465.X, filed Jul. 21, 2016, the entire content of which is incorporated herein by reference.

### TECHNICAL FIELD

The present application relates to a Content Delivery Network (CDN), and more specifically, to detection and scheduling method, device, and node of CDN.

### BACKGROUND ART

The implementation of CDN can avoid bottlenecks and links on the Internet that potentially affect data transmission speed and stability, such that content transmission is faster and more stable. With a layer of intelligent virtual network on the foundation of the existing Internet and formed by node servers arranged at various locations of the network, a CDN system can re-direct a user's request to a service node closest to the user according to thorough information such as the network traffic, the connection and loading situation of each node, the distance to the user, and the response time. The goal is to enable the user to acquire the desired content from nearby nodes, providing a solution to the crowded Internet, and improving the response speed when a user accesses a website.

The implementation of CDN for accessing a website can achieve the goal of acceleration. When a user accesses the website, the source site of the web site is no longer accessed directly. Instead, a CDN node nearby is accessed, and then the CDN node forwards the request to the source site. Moreover, CDN can cache resources, and an expiration time may be set for the resources of a source site. If the resources have not expired and are permitted to be cached by CDN, then CDN can cache the resources of the source site. When accessed by a user, CDN can directly provide the cached resources without accessing the source site again. CDN usually uses a backbone network, which has a very high bandwidth. Request forwarding by CDN will be much faster than direct access to a source site, and moreover, the presence of a cache system can further accelerate the user's access.

In some embodiments, an access process is divided into two phases: Phase I: from a user terminal to a CDN node with the consumed time defined as T1; Phase II: from the CDN node to a source site with the consumed time defined as T2. The consumed T1 is different when the user terminal accesses different CDN nodes. On the other hand, typically, the time to the source site is consistent for all the CDN nodes. Since the CDN nodes have a cache system, the total access time is T1+T2 when the cache is not the target, and T1 when the cache is the target. Therefore, the actual access time by a user may largely dependent on T1. In other words, the CDN acceleration effect can be more significant if a user terminal accesses a CDN node faster.

CDN scheduling can enable a user to access a CDN node in a more reasonable manner. An excellent scheduling strategy can schedule a user to the most suitable node within CDN, accelerate the access speed by the user to the maximum extent possible, and improve the Internet surfing experience.

According to existing technologies, the CDN scheduling mode follows the principle of “nearby access”, which connects a user to the closest node as much as possible through judgment of “spatial distance”+“service provider”. The reality is, however, that a close node may not necessarily be the node that the user can access the fastest. When the area in which the user is located does not have a node, in particular, access purely based on spatial distance is not reasonable. This is particularly the case for some small countries. As some regions have many countries, it might be impossible for CDN vendors to build nodes in every country. A country's node may have an excellent quality of service within the country itself, but may have very poor quality to other countries. For example, one country does not have CDN node, but the CDN node deployed in the closest country may have very poor service quality, while the CDN node deployed in another country that is slightly farther may have excellent service quality. In such a case, the Internet surfing experience of a user will be severely affected if nearby access is used according to the spatial distance. For nodes of approximately the same spatial distance, random scheduling will lead to an unstable access speed at the user side.

### SUMMARY

In view of this, the present disclosure provides the following examples.

In some embodiments, a CDN detection processing method may comprise: issuing one or more IP addresses in a first IP segment to a plurality of CDN nodes; receiving link detection results reported by the plurality of CDN nodes, the link detection results comprising information of time delay for accessing the IP addresses by the CDN nodes; and selecting, from the plurality of CDN nodes, a priority scheduling node of the first IP segment based at least on the information of time delay.

In some embodiments, a CDN detection device may comprise: an issuing module configured to issue one or more IP addresses in a first IP segment to a plurality of CDN nodes; a receiving module configured to receive link detection results reported by the plurality of CDN nodes, the link detection results comprising information of time delay for accessing the IP addresses by the CDN nodes; and a processing module configured to select, from the plurality of CDN nodes, a priority scheduling node of the first IP segment based at least on the information of time delay.

In some embodiments, a CDN detection processing device may comprise a processor and a non-transitory computer-readable memory, wherein: the memory is configured to store program codes; and the processor is configured to read the program codes from the memory and perform: issuing one or more IP addresses in a first IP segment to a plurality of CDN nodes; receiving link detection results reported by the plurality of CDN nodes, the link detection results comprising information of time delay for accessing the IP addresses by the CDN nodes; and selecting, from the plurality of CDN nodes, a priority scheduling node of the first IP segment based at least on the information of time delay.

The solutions above can determine a priority scheduling node for IP segments through actual link detection by CDN nodes on the IP segments, which can at least mitigate the deterioration of service quality in case of “nearby access” to a CDN node.

In view of this, the present disclosure further provides the following solutions.

In some embodiments, a CDN scheduling method implementable by a CDN scheduling node may comprise: receiving an access request from a user terminal, and determining, according to a terminal IP address carried in the access request, information of a first IP segment having the IP address; searching for a priority scheduling node of the first IP segment according to the information of the first IP segment, and providing the information of the identified priority scheduling node to the user terminal.

In some embodiments, a CDN scheduling node may comprise: a receiving module configured to receive an access request from a user terminal, and determine, according to a terminal IP address carried in the access request, information of a first IP segment having the IP address; and a scheduling module configured to search for a priority scheduling node of the first IP segment according to the information of the first IP segment, and provide information of the identified priority scheduling node to the user terminal.

The above CDN scheduling method and node can directly find the priority scheduling node of the first IP segment according to the information of the first IP segment, which can accelerate the processing of scheduling, while the above priority scheduling node can be obtained using the detection processing method described above.

### BRIEF DESCRIPTION OF THE DRAWINGS

FIG. 1 is a flowchart of a CDN detection processing method according to some embodiments of the present disclosure.

FIG. 2 is a schematic diagram of modules of a CDN detection processing device according to some embodiments of the present disclosure.

FIG. 3 is a flowchart of a CDN scheduling method according to some embodiments of the present disclosure.

FIG. 4 is a schematic diagram of modules of a CDN scheduling node according to some embodiments of the present disclosure.

FIG. 5 is a structural schematic diagram of a link detection system according to some embodiments of the present disclosure.

FIG. 6 is a schematic diagram I of the CDN scheduling method according to some embodiments of the present disclosure.

FIG. 7 is a schematic diagram II of the CDN scheduling method according to some embodiments of the present disclosure.

### DETAILED DESCRIPTION

In order to make the objectives, technical solutions and advantages of the present disclosure clearer, the embodiments of the present disclosure will be described in detail below with reference to the accompanying drawings. Provided that there is no conflict, the embodiments described herein and features in the embodiments may be combined freely in any way.

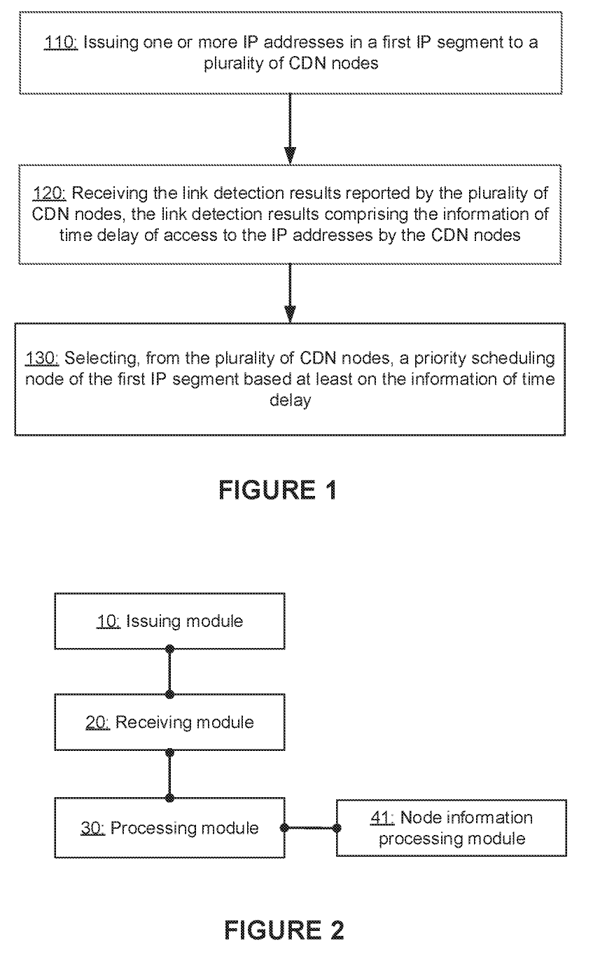

Some embodiments of the present disclosure provide a CDN detection processing method, which comprises the following detection processing process, as shown in FIG. 1:

Step 110 includes issuing one or more IP addresses in a first IP segment to a plurality of CDN nodes.

In one embodiment, the first IP segment is an IP segment used by one or more terminals from an IP library, and the one or more IP addresses in the first IP segment are IP addresses of the terminals. In other words, in one embodiment, the links from CDN nodes to user terminals are detected, and one or more of the CDN nodes are selected to be scheduled with priority for the user terminals of the first IP segment, so as to shorten the access time in the first phase of the actual access process by a user terminal described above. Nevertheless, the present application may also be used to detect the link from a CDN node to a source site to shorten the access time in the second phase of the actual access process by a user terminal.

The first IP segment herein may be used to represent one IP segment. In one embodiment, the first IP segment is an IP segment with no CDN node deployed in its area. For an IP segment with a CDN node deployed in its area, the CDN node deployed in its area can be directly used as the priority scheduling node of the IP segment. In another embodiment, however, the first IP segment may also be any IP segment in an IP segment set used by terminals from an IP library. Namely, for an IP segment with a CDN node deployed in its area, the detection processing method can be also used to select the priority scheduling node. Moreover, the description of relevant processing of the first IP segment is mere illustrative, and should not be construed that the method only processes one IP segment, but it should be construed that the detection processing method for the IP segment is also applicable to other similar IP segments.

For an IP segment with one or more CDN nodes deployed in its area, the CDN nodes deployed in its area can be directly used as the priority scheduling node of the IP segment. For example, a network request sent by a user in Shandong has the priority to be scheduled to a CDN node in Shandong. On the basis of the above, an service provider's information can be further introduced, and the service provider of which the node to be scheduled can be further determined according to the service provider of the network to which the IP segment belongs. For example, when there are a CDN node of Shandong Unicom and a CDN node of Shandong Telecom in the Shandong area, a user of Shandong Unicom will have the priority to be scheduled to the CDN node of Shandong Unicom, while a user of Shandong Telecom will have the priority to be scheduled to the CDN node of Shandong Telecom.

In one embodiment, the issuing one or more IP addresses in a first IP segment to a plurality of CDN nodes comprises: determining a geographic area corresponding to the first IP segment, the geographic area comprising continent, country, region, or self-defined area; issuing one or more IP addresses in the IP segment to a plurality of CDN nodes within the geographic area. It is not necessary to issue IP addresses in all IP segments to all CDN nodes, but it is necessary to choose a CDN node within a geographic area in which the first IP segment is located and then issue the IP addresses in the first IP segment to the CDN node. The larger the geographic area is, the more CDN nodes are to be detected, and it is more possible to select the optimal CDN node; nevertheless, the detection workload is high as well. In some embodiments, a proper geographic area may be selected according to actual needs. For example, if the area where an IP segment is located has many small countries, the geographic area may be a continent, and during issuing, the IP segments to be detected in the continent are issued to all CDN nodes in the continent, respectively. On the other hand, if the area where an IP segment is located is a big country, then the geographic area may be a country, or even a region (e.g., a province), and during issuing, the IP segments to be detected in the country or region are issued to all CDN nodes in the country or region, respectively.

Step 120 includes receiving the link detection results reported by the plurality of CDN nodes, the link detection results comprising the information of time delay for accessing the IP addresses by the CDN nodes.

For the link detection result reported by a CDN node, the information of time delay for accessing the IP addresses by the CDN node may be the time delay from the CDN node to the one or more IP addresses. When only one IP address is issued, the time delay for accessing the IP address by the CDN node is used directly as the time delay to access the first IP segment; when there is a plurality of IP addresses, an average time delay for accessing the IP addresses by the CDN node may be used as the time delay for the CDN node to access the first IP segment, or the minimum time delay thereof may be used as the time delay for the CDN node to access the first IP segment.

Step 130, selecting, from the plurality of CDN nodes, a priority scheduling node of the first IP segment based at least on the information of time delay.

In one embodiment, when a priority scheduling node is selected, a CDN node with the minimum time delay may be selected as the priority scheduling node of the first IP segment from the plurality of CDN nodes; alternatively, a CDN node with the minimum time delay that is shorter than a preset maximum time delay threshold may be selected from the plurality of CDN nodes. There may be many strategies for such a selection, and in some strategies, time delay is one of the factors, rather than the only one factor. When time delay is considered, other factors, such as loading, equipment capability and fees, may be further considered. When other factors are considered, the selected priority scheduling node may not necessarily be the CDN node with the minimum reported time delay, but may be a CDN node with the second minimum reported time delay, or any CDN node with a time delay shorter than a threshold.

The above detection processing may be performed by a CDN detection processing device, and the detection processing device may be disposed on any CDN entity, such as an innerDNS described below, a CDN node, or a newly added CDN node. Upon receiving a link detection result reported by a CDN node, the CDN detection processing device may process the link detection result in various ways. For example, assuming that a first IP segment has not stored a priority scheduling node, when a link detection result on IP addresses in the IP segment reported by a CDN node is received and its time delay meets the requirements, the CDN node may be first used as a priority scheduling node of the first IP segment, and its time delay is recorded. When a link detection result on IP addresses in the IP segment reported by another CDN node is received subsequently, the time delay in the detection result may be compared with the stored time delay. If the time delay in the detection result is shorter than the recorded time delay, the recorded time delay may be updated with the time delay in the detection result, and corresponding node information is updated.

In one embodiment, after a priority scheduling node of the first IP segment has been selected, the priority scheduling node is further stored as the node information of the first IP segment; if node information of the first IP segment has already been stored, the node information of the first IP segment is updated according to the selected priority scheduling node. For example, the node information may be recorded in a suffix of the first IP segment in the IP library.

In one example, all CDN vendors would maintain information in an IP library. The record formats of the IP libraries are slightly different, but comprise: ip segment information and the information of the continent, country and region where the ip is located, as shown below;

16793600, 16809983, as.jp.x.x.x.x

16809984, 16842751, as.th.x.x.x.x

The first column indicates the start IP address of an IP segment

The second column indicates the end IP address of the IP segment

The third column, also referred to as the suffix of an IP segment, indicates the information of the continent, country and region where the IP is located. For example, “as” represents Asia, “jp” represents Japan, etc.

As such, the content of an IP library can be expanded by adding node information in the third column, namely recording in the suffix of an IP segment in the IP library, to represent a priority scheduling node of an IP segment. For example, it can be directly added behind the area information. In one example, it is originally as.in.x.x.x and becomes as.in.x.x.x.node after expansion. The value of “node” can be defined as follows:

node=“default”, indicating that one or more CDN nodes are deployed in the area where the IP segment is located and the one or more CDN nodes deployed in the area are used as the one or more priority scheduling nodes of the IP segment.

node=“none”, indicating that no CDN node is deployed in the area where the IP segment is located, and no appropriate CDN node has been detected yet. At this moment, access can be made to a nearby node randomly.

node=“node name”, indicating the optimal scheduling node of the IP segment that is obtained through detection. Requests from a user terminal of the IP segment have the priority to be scheduled to the node.

In some embodiments, when a CDN node is deployed in the area where an IP segment is located, the priority scheduling node of the IP segment may also be determined by means of detection. The above values of node are only exemplary. For example, when a CDN node is deployed in the area where an IP segment is located, the value of node may also be represented directly by “node name”.

In one embodiment, an expiration time can be set for node information. In other words, the priority scheduling node of a first IP segment selected according to the results of a detection may not be permanently applicable, but applicable only in a period of time. In one example, the following processing can be performed: when saving or updating the node information of the first IP segment, setting the state of the node information of the first IP segment to valid; calculating the storage time or update time of the node information of the first IP segment, and if the storage time or update time exceeds a node validity time set for the first IP segment, setting the state of the node information of the first IP segment to invalid. The valid state and the invalid state may be represented by one state parameter, such as “node_expired”. For example, when the value of the parameter is “yes”, it indicates that the node information has expired and its state is invalid; if the value of the parameter is “no”, on the other hand, it indicates that the node information has not expired, and its state is valid.

In one example, to calculate the storage time or update time of the node, a corresponding timer may be activated at the time of storing or updating, and the timing length of the timer is set to be the period of validity of the node of the first IP segment. When the timer exceeds the set length, the state of the node information of the first IP segment is set to invalid. In another example, the expiration time of the node information of a first IP segment may also be directly calculated and recorded at the time of storing or updating, and the IP segments in the IP library are then checked at regular or random times. If the current system time exceeds the expiration time, it indicates that the node information of the first IP segment is invalid, otherwise the node information of the first IP segment is valid. Furthermore, a node expiration time may be set for all IP segments in the IP library, or a node expiration time may be set for each IP segment, or the IP segments may be divided into groups and a node expiration time is set for each group, etc. For IP segments with CDN nodes deployed in their areas, they may be set as never expired, in which case they will not be issued, and the processing on the IP segments in the IP library can be unified.

In one embodiment, after the state of the node information of the first IP segment is set to invalid, it may further comprise: setting the value of the node information of the first IP segment to a preset value indicating that no priority scheduling node exists. In the example above, the value of node may be set to a value of “none”, and in such a way, whether a valid priority scheduling node exists can be directly learned according to the value of node, obviating steps to check other parameters.

The detection processing process may be triggered on the basis of one or more of the following events:

First, detecting that the state of the node information of the first IP segment is invalid;

Second, detecting that the network to which the first IP segment belongs changes, the network change comprising network service provider change and/or network upgrade.

Wherein, the detection of the state of node information of IP segments may be performed at regular or random times. For example, detection is performed in a cycle of one day, several days, one week or several weeks. If it is detected that the state of the node information of an IP segment is invalid, one or more IP addresses thereof may be issued to corresponding CDN nodes for link detection, and at the same time, the value of the node information may be set to “none”.

In some embodiments, a CDN detection processing device, as shown in FIG. 2, may comprise:

an issuing module 10 configured to issue one or more IP addresses in a first IP segment to a plurality of CDN nodes;

a receiving module 20 configured to receive the link detection results reported by the plurality of CDN nodes, the link detection results comprising the information of time delay for accessing the IP addresses by the CDN nodes; and

a processing module 30 configured to select, from the plurality of CDN nodes, a priority scheduling node of the first IP segment based at least on the information of time delay.

Optionally, the issuing module issuing one or more IP addresses in a first IP segment to a plurality of CDN nodes comprises: determining a geographic area corresponding to the first IP segment, the geographic area comprising continent, country, region or self-defined area; and issuing one or more IP addresses in the IP segment to a plurality of CDN nodes within the geographic area.

Optionally, the processing module selecting, from the plurality of CDN nodes, a priority scheduling node of the first IP segment based at least on the information of time delay comprises: selecting, from the plurality of CDN nodes, a CDN node with the minimum time delay as the priority scheduling node of the first IP segment; alternatively, selecting, from the plurality of CDN nodes, a CDN node with the minimum time delay that is shorter than a preset maximum time delay threshold.

Optionally, after selecting a priority scheduling node of the first IP segment, the processing module further stores the selected priority scheduling node as the node information of the first IP segment; and/or, updates the node information of the first IP segment according to the selected priority scheduling node.

The device may further comprises: a node information processing module 41 configured to set the state of the node information of the first IP segment to valid when saving or updating the node information of the first IP segment; and calculate the storage time or update time of the node information of the first IP segment, and if the storage time or update time exceeds a node validity time set for the first IP segment, set the state of the node information of the first IP segment to invalid.

Optionally, the issuing module triggers issuing on the basis of one or more of the following events: detecting that the state of the node information of the first IP segment is invalid; detecting that the network to which the first IP segment belongs changes, the network change comprising network service provider change and/or network upgrade.

Optionally, the first IP segment is an IP segment used by a terminal from the IP library and with no CDN node deployed in its area, and one or more IP addresses in the first IP segment are the IP addresses of the terminal.

As such, a priority scheduling node for IP segments can be determined through actual link detection by CDN nodes on the IP segments, which can avoid the issue that the service quality is not guaranteed in case of “nearby access” to a CDN node. Through the management of expiration time of node information, moreover, the node information can be only valid within a period of time, which can avoid inaccurate scheduling due to decreased node service quality, enable all information of an IP library to be promptly updated, and enhance the accuracy of the data.

In prior art, CDN scheduling finds a corresponding IP segment according to an IP address carried in an access request, and determines whether the user's area is deployed with a CDN node according to specific node distribution. If a CDN node is deployed, the deployed CDN node is selected and provided to the user for access. When a plurality of CDN nodes are deployed in the same area, it is necessary to select a CDN node of the same service provider as the one corresponding to the IP segment. The scheduling efficiency is not high.

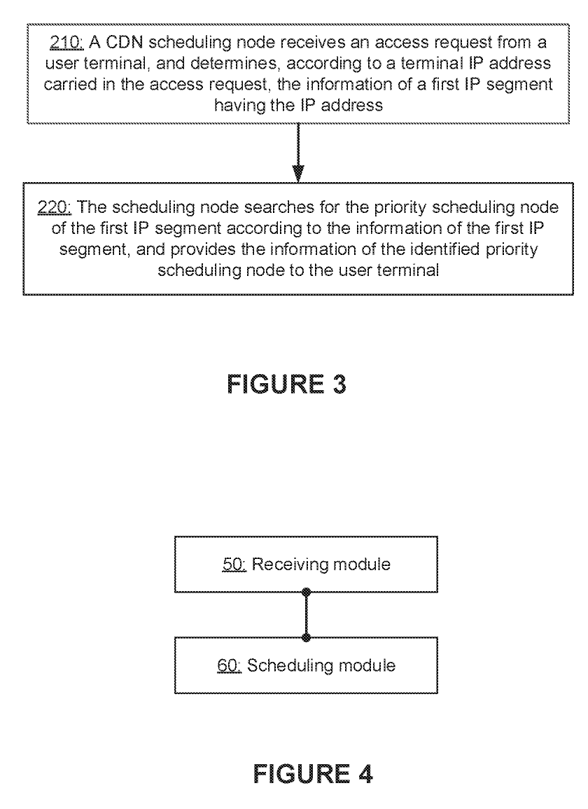

In some embodiments, a CDN scheduling method, as shown in FIG. 3, may comprise:

Step 210, a CDN scheduling node receives an access request from a user terminal, and determines, according to a terminal IP address carried in the access request, the information of a first IP segment having the IP address;

Step 220, the scheduling node searches for the priority scheduling node of the first IP segment according to the information of the first IP segment, and provides the information of the identified priority scheduling node to the user terminal.

In one embodiment, the priority scheduling node of the first IP segment is recorded in a suffix of the first IP segment from the IP library, e.g., as the node information “node” with a format as described above. The “direct search” can obviate multiple searches for IP segments and node information thereof in the same data structure, such as the same array or the same table. Regardless of the scheduling strategies, such as priority scheduling to a CDN node in the area, priority scheduling to a CDN node of the same service provider in the area, or priority scheduling to a CDN node with the minimum time delay according to the actual detection, corresponding node(s) can be directly found without complex determination.

In some embodiments, a CDN scheduling node, as shown in FIG. 4, may comprise:

a receiving module 50 configured to receive an access request from a user terminal, and determine, according to a terminal IP address carried in the access request, the information of a first IP segment having the IP address;

a scheduling module 60 configured to search for the priority scheduling node of the first IP segment according to the information of the first IP segment, and provide the information of the identified priority scheduling node to the user terminal.

Optionally, the scheduling module searching for the priority scheduling node of the first IP segment according to the information of the first IP segment comprises: searching for a suffix of the first IP segment in the IP library according to the information of the first IP segment, and using the node information in the suffix as the information of a priority scheduling node of the first IP segment.

The above method may be used to directly find a priority scheduling node for an IP segment with or without a CDN node deployed in its area. For an IP segment with a CDN node deployed in its area, the CDN node deployed in its area may be directly used as the priority scheduling node of the IP segment. Alternatively, the detection method described above with reference to FIG. 1 may also be used to select a priority scheduling node of the IP segment. Alternatively, a priority scheduling node may be obtained in other ways. As such, the node information of a priority scheduling node can be introduced into an IP library and reasonable use of the newly introduced node information can be made, obviating multiple searches via intermediate parameters and the efficiency is higher. Moreover, the introduction of the information can also be combined with a scheduling strategy of spatial distance, which ensures the rationality of scheduling.

When the detection method described above with reference to FIG. 1 is used to select a priority scheduling node of an IP segment, the priority scheduling node is selected and scheduled according to real link data, rather than scheduling merely according to spatial distance. Real link data can accurately reflect the access quality and is the most reliable data in scheduling. As a result, a user can be scheduled, as much as possible, to a node with relatively good service quality, thereby improving the user experience. Even when the detection method described above with reference to FIG. 1 is not used to select a priority scheduling node of an IP segment, however, the scheduling method can still strengthen the scheduling operability.

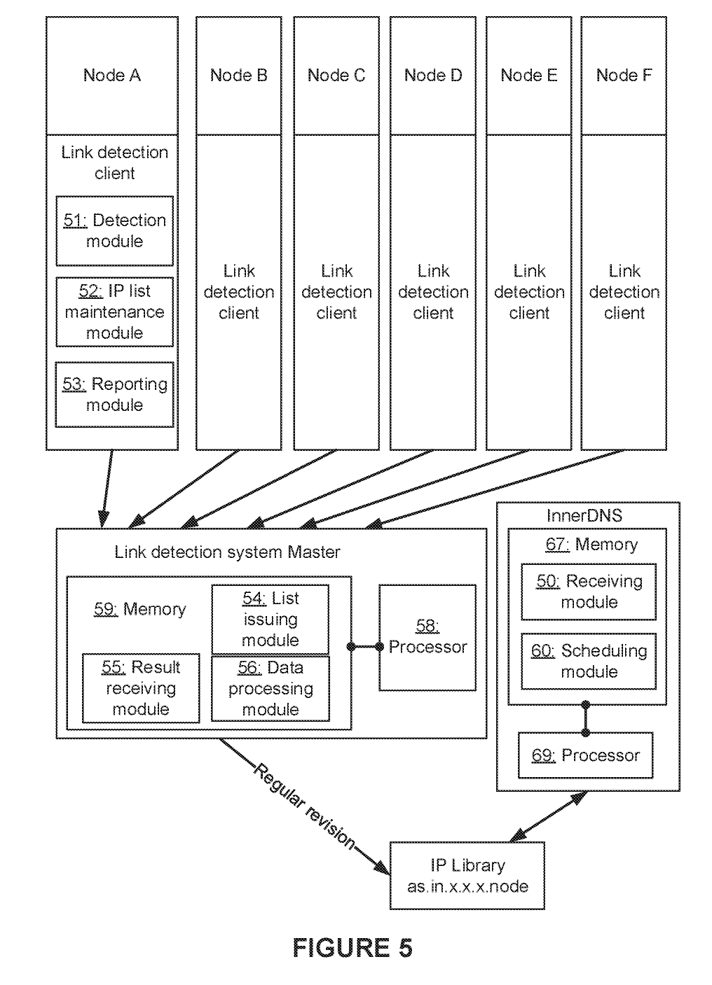

In some embodiments, a CDN detection processing device (e.g., a link detection system master described below with reference to FIG. 5), may comprise a processor (e.g., CPU (central processing unit)) and a memory, wherein:

the memory (e.g., memory 59 described below with reference to FIG. 5) is configured to store program codes;

the processor (e.g., processor 58 described below with reference to FIG. 5) is configured to read the program codes from the memory and perform the following link detection method: issuing one or more IP addresses in a first IP segment to a plurality of CDN nodes; receiving the link detection results reported by the plurality of CDN nodes, the link detection results comprising the information of time delay for accessing the IP addresses by the CDN nodes; and selecting, from the plurality of CDN nodes, a priority scheduling node of the first IP segment based at least on the information of time delay.

The above link detection method may further be any one of the link detection methods described above with reference to FIG. 1.

Several examples of application will be used for further description below.

In some embodiments, the present example relates to a CDN link detection system. As shown in FIG. 5, the link detection system comprises one or more link detection clients and a master of the link detection system. The master is an example of the detection processing device described above and connects to an IP library of CDN, while the innerDNS, i.e., inner Domain Name System, of CDN is connected to the IP library. The innerDNS of CDN is a CDN scheduling node. The master may be deployed at an independent node, or may be deployed together with an existing node in CDN, such as the innerDNS. The innerDNS may comprise a processor 69 and a non-transitory computer-readable memory 67. The memory 67 may store instructions (e.g., the receiving module 50, the scheduling module 60) that, when executed by the processor 69, cause the processor 69 to perform various steps and method described herein with respect to the innerDNS.

The link detection client in the present example (e.g., the link detection client associated with node A) comprises a processor and a memory (not shown in the figure) that comprises a detection module 51, an IP list maintenance module 52, and a reporting module 53, wherein:

the IP list maintenance module is configured to store and update IP list data, the IP list being issued by the master of the link detection system.

The detection module is configured to read the IP list information, detect the link data of IP addresses, one by one, in the IP list, such as time delay, and save the results.

The reporting module is configured to report, after the completion of each round of detection by the detection module, the results to the master. The reported results may be the link data of each IP address in the IP list.

The link detection client may periodically activate detection. There are a variety of ways for link detection, most of which follow the ICMP (Internet Control Message Protocol). In the present example, the link detection is performed by means of traceroute. After the detection, link data, such as what routes need to be passed from the current CDN node to a target IP address and time delay to reach the target IP address, are provided. The time delay to an IP address may be detected once, or may be detected for multiple times to take an average value.

The master of the link detection system comprises a memory 59 and a processor 58, the memory 59 storing instructions that comprise a list issuing module 54, a result receiving module 55, and a data processing module 56, where:

the list issuing module is configured to extract IP segments with, for example, the node information in an invalid state from the IP library, extract some IP addresses from each IP segment, and issue them to CDN nodes on the continent (or in other geographic areas) where each IP segment is located. In the present example, no transcontinental detection is performed on links between a node and an IP segment. During issuing, different continent IP lists are issued to CDN nodes on the continents, and no transcontinental issuing will be made. However, this is only exemplary. An IP list may be issued at a fixed time interval. When the network to which the IP segment belongs changes, such as the network service provider changes or the network is upgraded, however, the IP addresses in the IP segment may also be used to immediately generate an IP list for issuing. The memory 59 may be a non-transitory and computer-readable storage medium storing instructions (e.g., the list issuing module 54, the result receiving module 55, the data processing module 56) that, when executed by the processor 58, perform the corresponding steps and methods described herein. The list issuing module 54 may correspond to the issuing module 10 described above, the result receiving module 55 may correspond to the receiving module 20 described above, and the data processing module 56 may correspond to the processing module 30 described above. In some embodiments, the link detection system Master may be implemented on the innerDNS. That is, the link detection system Master and the innerDNS may be integrated together by merging the processor 58 and the processor 69 and merging the memory 59 and the memory 67. Further, various steps and methods performed by the link detection system Master and the innerDNS may be merged.

The data receiving module is configured to collect link detection results reported by CDN nodes.

The data processing module is configured to select, from the plurality of CDN nodes, a priority scheduling node of the first IP segment based at least on the information of time delay. For example, the module first selects a link detection result with the reported time delay satisfying the maximum time delay threshold requirement, wherein the maximum time delay threshold may be user defined, for example, to 200 ms; after a link detection result that satisfies the requirement is selected, updates the IP library according to the information of time delay therein (as described above), and at the same time, activates a timing task, such as activates a timer or calculates the expiration time, and updates the node expiration information (e.g., node_expired).

The master may further perform health inspection on the client by scanning if all nodes have normally-operated link detection processes. If the operation is not normal, the detection process is re-activated.

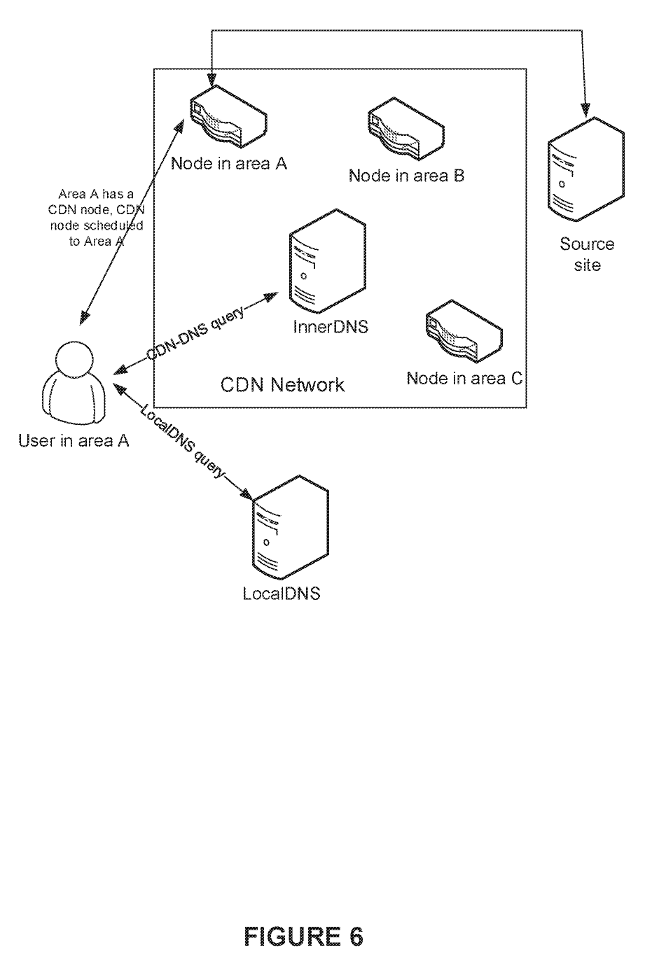

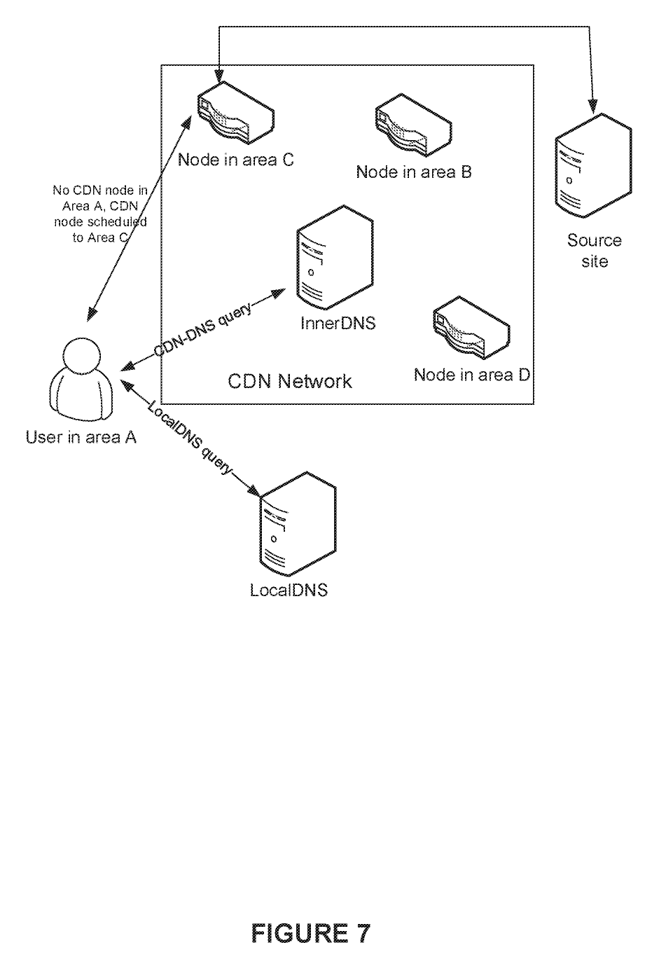

In some embodiments, the present example relates to CDN scheduling. Referring to FIG. 6 and FIG. 7, the scheduling flow comprises:

Step I, a user initiates to access a URL of a domain name A, and the domain name A has been accelerated at CDN;

Step II, a local DNS (localDNS) redirects the request to an innerDNS;

Step III, the innerDNS searches for the priority scheduling node of the IP segment according to the IP segment in which the user IP address is located;

Step IV, the innerDNS provides the identified priority scheduling node to the user for access.

Step V, the user accesses the provided CDN node, and the CDN node forwards the access to the source site.

In FIG. 6, the IP segment in which user A is located is an IP segment in the area A, and a CDN node is deployed in the area A. As a result, the innerDNS provides the CDN node in the area A to the user in Step IV. In FIG. 7, the IP segment in which user A is located is in the area A, and no CDN node is deployed in the area A. The priority scheduling node selected, through link detection, for the IP segment is a CDN node deployed in the area C. Then, the innerDNS provides the CDN node in the area C to the user in Step IV.

The sequence numbers of the above embodiments of the present disclosure are for description only and do not represent the quality of the embodiments. Through the above description of implementation modes, those skilled in the art can clearly understand that the methods according to the above embodiments may be implemented by means of software plus a necessary general hardware platform, and certainly, they may be implemented by means of hardware. However, the former is a better implementation mode in many cases. Based on such a understanding, the technical solutions in the embodiments of the present disclosure or the part thereof that contributes to the prior art may essentially be represented in a form of software product. The computer software product is stored in a storage medium (e.g. ROM/RAM, magnetic disk, optical disc, etc.), comprising a number of commands to cause a terminal device (which may be a cell phone, a computer, a server, or a network device) to execute methods described in all embodiments of the present disclosure.

Only preferred embodiments of the present disclosure are described above, which are not used to limit the present disclosure. To those skilled in the art, various modifications and variations may be made to the present disclosure. Any modification, equivalent substitution or improvement made within the spirit and principle of the present disclosure shall be encompassed by the present disclosure.

1. A Content Delivery Network (CDN) detection method, comprising:
issuing one or more IP addresses in a first IP segment to a plurality of CDN nodes;
receiving link detection results reported by the plurality of CDN nodes, the link detection results comprising information of time delay for accessing the IP addresses by the CDN nodes; and
selecting, from the plurality of CDN nodes, a priority scheduling node of the first IP segment based at least on the information of time delay.

2. The method according to claim 1, wherein:
the first IP segment is an IP segment used by a terminal from an IP library; and
the one or more IP addresses in the first IP segment are IP addresses of the terminal.

3. The method according to claim 2, wherein:
the first IP segment is an IP segment with no CDN node deployed in an area associated with the IP segment.

4. The method according to claim 1, wherein:
the issuing one or more IP addresses in a first IP segment to a plurality of CDN nodes comprises:
determining a geographic area corresponding to the first IP segment, the geographic area comprising one of: continent, country, region, or self-defined area; and
issuing one or more IP addresses in the IP segment to a plurality of CDN nodes within the geographic area.

5. The method according to claim 1, wherein:
the selecting, from the plurality of CDN nodes, a priority scheduling node of the first IP segment based at least on the information of time delay comprises:
selecting, from the plurality of CDN nodes, a CDN node with a minimum time delay as the priority scheduling node of the first IP segment.

6. The method according to claim 1, wherein:
the selecting, from the plurality of CDN nodes, a priority scheduling node of the first IP segment based at least on the information of time delay comprises: selecting, from the plurality of CDN nodes, a CDN node with a minimum time delay shorter than a preset maximum time delay threshold.

7. The method according to claim 1, further comprising at least one of:
storing the selected priority scheduling node as node information of the first IP segment; or
updating node information of the first IP segment according to the selected priority scheduling node.

8. The method according to claim 7, wherein:
the node information is recorded in a suffix of the first IP segment in an IP library.

9. The method according to claim 7, further comprising:
when storing and/or updating the node information of the first IP segment, setting a state of the node information of the first IP segment to valid;
calculating a storage time and/or update time of the node information of the first IP segment; and
in response to the storage time or update time exceeding a node validity time set for the first IP segment, setting the state of the node information of the first IP segment to invalid.

10. The method according to claim 9, further comprising:
setting a value of the node information of the first IP segment to a preset value indicating that no priority scheduling node exists.

11. The method according to claim 9, wherein:
the method is triggered on the basis of one or more of the following events:
detecting that the state of the node information of the first IP segment is invalid; and
detecting that a network to which the first IP segment belongs changes, the network change comprising at least one of network service provider change or network upgrade.

12. The method according to claim 1, further comprising:
receiving an access request from a user terminal;
determining, according to a terminal IP address carried in the access request, information of the first IP segment having the terminal IP address;
searching for the priority scheduling node of the first IP segment according to the information of the first IP segment; and
providing the information of the identified priority scheduling node to the user terminal.

13. The method according to claim 12, wherein:
the priority scheduling node of the first IP segment is recorded in a suffix of the first IP segment in an IP library.

14. A Content Delivery Network (CDN) detection device, comprising:
an issuing module configured to issue one or more IP addresses in a first IP segment to a plurality of CDN nodes;
a receiving module configured to receive link detection results reported by the plurality of CDN nodes, the link detection results comprising information of time delay for accessing the IP addresses by the CDN nodes; and
a processing module configured to select, from the plurality of CDN nodes, a priority scheduling node of the first IP segment based at least on the information of time delay.

15. The device according to claim 14, wherein:
to select, from the plurality of CDN nodes, the priority scheduling node of the first IP segment based at least on the information of time delay, the processing module is configured to: select, from the plurality of CDN nodes, a CDN node with a minimum time delay as the priority scheduling node of the first IP segment.

16. The device according to claim 14, wherein:
the receiving module is further configured to receive an access request from a user terminal, and determine, according to a terminal IP address carried in the access request, information of the first IP segment having the terminal IP address; and
the device further comprises a scheduling module configured to search for the priority scheduling node of the first IP segment according to the information of the first IP segment, and provide information of the identified priority scheduling node to the user terminal.

17. The device according to claim 16, wherein:
to search for the priority scheduling node of the first IP segment according to the information of the first IP segment, the scheduling module is configured to: search for a suffix of the first IP segment in an IP library according to the information of the first IP segment, and use node information in the suffix as the information of the priority scheduling node of the first IP segment.

18. A device comprising a processor and a non-transitory computer-readable memory, wherein:
the memory stores program codes; and
the processor is configured to execute the program codes from the memory and perform:
issuing one or more IP addresses in a first IP segment to a plurality of Content Delivery Network (CDN) nodes;
receiving link detection results reported by the plurality of CDN nodes, the link detection results comprising information of time delay for accessing the IP addresses by the CDN nodes; and
selecting, from the plurality of CDN nodes, a priority scheduling node of the first IP segment based at least on the information of time delay.

19. The device according to claim 18, wherein:
the processor is configured to execute the program codes from the memory and further perform triggering issuing on the basis of one or more of the following events:
detecting that a state of the node information of the first IP segment is invalid; and
detecting that a network to which the first IP segment belongs changes, the network change comprising at least one of network service provider change or network upgrade.

20. The device according to claim 18, wherein:
the first IP segment is an IP segment used by a terminal in an IP library and with no CDN node deployed in an area associated with the IP segment; and
the one or more IP addresses in the first IP segment are IP addresses of the terminal.
